(19) United States
(12) Patent Application Publication
(10) Pub. No.: US 2008/0262679 A1
(43) Pub. Date: Oct. 23, 2008

(54) Safety Device for a Motor Vehicle

(75) Inventors: Karl-Heinz Baumann, Bondorf (DE); Michael Fehring, Neuhausen (DE); Justen Rainer, Altdorf (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/631,337

(22) PCT Filed: Jun. 28, 2005
(86) PCT No.: PCT/EP2005/006922

§ 371 Date: Jan. 18, 2008

(30) Foreign Application Priority Data
Jul. 2, 2004 (DE) 102004032139.6

(51) Int. Cl. B60N 2/48; B60N 2/427; B60R 21/0136

(52) U.S. Cl. 701/45

(57) ABSTRACT

A safety device for a motor vehicle, includes an active headrest which is provided on a backrest of a vehicle seat and a control unit which actuates a headrest-deployment device as a function of the evaluation of the signals from a crash sensor when an accident event occurs such that the active headrest is deployed into a headrest position which is optimum in terms of occupant safety. The control unit actuates at least one component of the vehicle seat as a function of the evaluation of data which is relevant in terms of driving safety before the expected accident event occurs such that the vehicle seat is moved to an optimum starting position for deploying the active headrest when the accident event occurs.

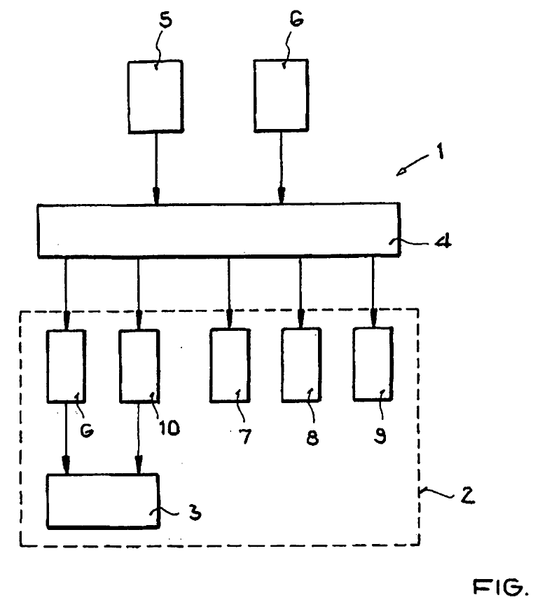

### CROSS REFERENCE TO RELATED APPLICATIONS

This application is a National Stage of PCT International Application No. PCT/EP2005/006922, filed Jun. 28, 2005, which claims priority under 35 U.S.C. § 119 to German Patent Application No. 10 2004 032 139.6 filed Jul. 2, 2005, the entire disclosures of which are herein expressly incorporated by reference.

### BACKGROUND AND SUMMARY OF THE INVENTION

The invention relates to a safety device for a motor vehicle, comprising an active headrest provided on a backrest of a vehicle seat.

DE 199 24 236 A1 discloses an active headrest for a motor vehicle seat, comprising an apparatus which detects a rear-end impact on the motor-vehicle. The headrest, which is integrated in the backrest, can be displaced forward during the rear-end impact by a mechanism which is coupled to the apparatus and to the headrest. In addition, a spring arrangement in conjunction with a releasable mechanical locking mechanism is provided, so that the headrest is stopped from moving forward in the normal operating state by spring pre-stress. A deployment system is connected to a sensor which detects the rear-end impact and to the locking mechanism of the headrest such that the locking means can be released when the sensor responds.

DE 199 47 318 A1 describes a vehicle with a seat backrest and a headrest, which is provided on said seat backrest, and an actuating system, which comprises a crash or precrash sensor, for vertically moving parts of the headrest to an operating position above the backrest as a result of a crash. The headrest is supported in its operating position against the roof of the vehicle and has two parts which are arranged one in the other in a telescopic manner only in crash-free periods and can be moved vertically in relation to one another in the event of a crash.

In addition, DE 100 47 406 A1 describes a headrest for a motor vehicle, with a stationary support part and a movable, pre-stressed part, it being possible to move the movable part from a normal position to a protection position. The movable part is moved from the normal position to the protection position when a crash is detected. A deployment device for the movable part is triggered by an electrical pulse from a crash sensor.

Furthermore, DE 44 11 184 C2 discloses a restraining belt system for a seat in a vehicle, comprising a seat belt and a belt tensioner for securing a passenger on the seat. An apparatus determines the distance from an object and the corresponding relative velocity. This can be used to determine the expected time until a possible collision between the vehicle and the object. A control unit generates a control signal which increases the force of the belt tensioner in good time before the possible collision. If a collision can be avoided, the force of the belt tensioner is reduced again. The controllable belt tensioner is designed as a pretensioner which is active only up to a predefined pre-stress before the collision, with a further belt tensioner being triggered for tauter tightening of the seatbelt if the collision actually takes place.

DE 101 213 386 C1 describes a method for actuating a reversible occupant protection means in a motor vehicle with a sensor system which detects driving state data. Instances of emergency braking, oversteering and understeering of the motor vehicle are monitored as driving state data. The occupant protection means is triggered as a function of such a state. The driving state data can additionally be used to determine the direction from which the greatest danger can be expected. The occupant protection means is actuated in such a way that protection is provided in accordance with the direction of greatest danger.

One object of exemplary embodiments of the present invention involves specifying a safety device for a motor vehicle, comprising an active headrest which is provided on a backrest of a vehicle seat and provides a greater degree of occupant protection compared to the safety devices known from the prior art.

Said object is achieved by a safety device for a motor-vehicle, comprising an active headrest which is provided on a backrest of a vehicle seat and has a control unit that actuates at least one component of the vehicle seat as a function of the evaluation of data which is relevant in terms of driving safety before the expected accident event occurs such that the vehicle seat is moved to an optimum starting position for deploying the active headrest when the accident event occurs.

The safety device for the motor vehicle comprises the backrest of the vehicle seat, with the active headrest provided on it, and the control unit which actuates the headrest-deployment device as a function of the evaluation of the signals from the crash sensor when an accident event occurs such that the active headrest is deployed into the headrest position which is optimum in terms of occupant safety. The vehicle seat, and therefore the active headrest, are moved to the optimum starting position for deploying or activating the active headrest even before the accident event occurs. Already assuming the optimum starting position before the actual accident event ensures that the headrest position which is optimum in terms of safety is reached in good time.

The active headrest is initially activated by the rear-end impact. In the normal operating state, the headrest is pre-stressed by springs and stopped from moving forward. The crash sensor is provided in order to detect a rear-end impact. The safety device according to the invention takes safety measures which are matched to one another and ensure that the occupant is comprehensively protected before and during the course of the accident event.

In one exemplary aspect of the present invention, a seat backrest, the active headrest and/or a seat cushion, which can be moved in terms of its longitudinal position and/or its inclination, are provided as components of the vehicle seat. The head and chest of the occupant should be supported as early and as simultaneously as possible. To this end, it is advantageous to position the components of the vehicle seat, in particular the active headrest and the seat backrest, in a manner correlated over time. The predefined optimum starting position for deploying the active headrest is reached more quickly and an undesired relative distance between the active headrest and the seat backrest, which distance may form when these two components of the vehicle seat are not positioned at the same time, can be avoided.

The data which is relevant in terms of driving safety may include, for example, driving state variables. Variables such as vehicle speed, yaw acceleration, longitudinal acceleration and lateral acceleration, brake pedal position and accelerator pedal position and the steering angle may be used as driving state variables. Furthermore, the status of operator control elements such as indicators and the hazard warning lights and also the status of sensors and controllers which relate to the motor vehicle can be used as the vehicle state variable.

As an alternative or in addition, the data which is relevant in terms of driving safety may be data about the surroundings. Data about the surroundings refers to data which is provided by sensors for the surroundings, telematics systems and by communication between the motor vehicle in question and other motor vehicles and stationary communications systems. Examples of data about the surroundings include information relating to the current position, the category of road, and the lane in which the motor vehicle in question is travelling. Further data about the surroundings includes, inter alia, the road state, temperature, weather conditions, lighting conditions and the speed, distance, type and size of motor vehicles travelling in front, alongside or behind or oncoming motor vehicles and of other road users.

In accordance with exemplary embodiments of the present invention, the data which is relevant in terms of driving safety can include evaluated driver activities. Detection of driver activities includes, for example, detecting the eye movement of the driver, the direction in which he is looking and also the operator control operations being made on operated control elements, for example the steering wheel, gear selection lever and brake pedal. By evaluating a plurality of items of safety-relevant data, it is possible, when required, to use the control unit to determine the correct time to move the vehicle seat to the optimum starting position for deploying the active headrest when the accident event occurs.

Other objects, advantages and novel features of the present invention will become apparent from the following detailed description of the invention when considered in conjunction with the accompanying drawings.

### BRIEF DESCRIPTION OF THE DRAWING FIGURES

The invention is explained in greater detail in the single FIGURE with reference to an exemplary embodiment, the FIGURE showing a block diagram of a detail of a safety device for a motor vehicle comprising an active headrest which is provided on a backrest of a vehicle seat.

### DETAILED DESCRIPTION OF THE DRAWINGS

A safety device 1 for a motor vehicle (not illustrated any further) has an active headrest 3 which is arranged on a backrest of a vehicle seat 2. The vehicle seat 3 may be any desired seat of the motor vehicle, in particular a backseat. The active headrest 3 is used to protect an occupant against the so-called “whiplash effect” which occurs particularly in the event of a rear-end collision. The distance between the active headrest 3 and the head of the respective occupant is reduced by moving said the active headrest forward. The head of the occupant of the motor vehicle can therefore be intercepted earlier when the vehicle is hit from the rear and the load on the cervical spine can be reduced. In this exemplary embodiment, the active headrest 3 is pre-stressed by springs in the normal operating state and is stopped from moving forward. The locking mechanism is released in order to deploy the active headrest 3. However, the active headrest 3 may also have another technical design which largely prevents the “whiplash effect” or reduces its effect.

A control unit 4 actuates a headrest-deployment device 6 as a function of the evaluation of the signals from a crash sensor 5 when an accident event occurs in such a way that the active headrest 3 is deployed into a headrest position which is optimum in terms of occupant safety. It is sufficient to activate the active headrest 3 only when the actual accident event occurs since the active headrest 3 can be activated so quickly that its protective action comes into effect in good time in order to protect the occupant. The crash sensor 5 is arranged in a rear region of the motor vehicle in order to detect a rear-end impact. It is also possible for additional sensors 5 to be provided at other installation positions on the motor vehicle in order to detect accident events.

In addition, the control unit 4 actuates components of the vehicle seat 2 as a function of the evaluation of data 11 which is relevant in terms of driving safety before the expected accident event occurs such that the vehicle seat 2 is moved to an optimum starting position for deploying the active headrest 3 when the accident event occurs. The data 11 which is relevant in terms of driving safety includes driving state variables, data about the surroundings and/or evaluated driver activities.

A seat backrest 7, the active headrest 3 itself and a seat cushion 8, which can be moved in terms of its longitudinal position and/or its inclination, are provided as components of the vehicle seat 2. Positioning of the active headrest 3, so-called headrest conditioning, and the seat backrest 7 can be carried out in a manner correlated over time. The active headrest 3 is positioned before the actual accident event by means of an adjusting drive 10. The adjusting drives for the other components of the vehicle seat 2 are not illustrated separately. The components of the vehicle seat 2 may also be moved in a different combination in parallel with one another over time or possibly even alone. The seat backrest 7 is moved for setting-up purposes at a speed of, for example, approximately 3.5° per second. The active headrest 3 is accordingly preemptively moved closer to the occupant at, for example, approximately 50 millimeters per second in the direction of the head to the ideal starting position for deploying the active headrest 3 into the headrest position which is optimum in terms of occupant safety. After the active headrest 3 is deployed, it moves forward by, for example, approximately 40 millimeters in order to effectively support the head of the occupant in good time before the occupant begins to move. If the accident event does not occur, the active headrest is not activated or deployed in this scenario, and the components of the vehicle seat 2 can again be moved back to their original positions.

A belt system 9 of the vehicle seat 2 and/or other preemptive, reversible occupant protection means can be activated before the expected accident event occurs.

The inventive safety device 1 for the motor vehicle, comprising the active headrest 3 which is provided on the backrest of the vehicle seat 2 ensures a high degree of occupant safety. In particular, the active headrest 3 is moved to the headrest position which is optimum for the occupant before and during the actual course of the accident event. The safety measures can be combined with other preemptive occupant protection means. The safety device 1 can be realized with an only low financial outlay since cost-intensive components of the safety device 1 are already provided in motor vehicles as standard.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A safety device for a motor vehicle, comprising:
an active headrest which is provided on a backrest of a vehicle seat; and
a control unit which actuates a headrest-deployment device as a function of the evaluation of the signals from a crash sensor when an accident event occurs in such a way that the active headrest is deployed into a headrest position which is optimum in terms of occupant safety, wherein the control unit actuates at least one component of the vehicle seat as a function of an evaluation of data which is relevant in terms of driving safety before the expected accident event occurs in such a way that the vehicle seat is moved to an optimum starting position for deploying the active headrest when the accident event occurs.

2. The safety device as claimed in claim 1, wherein a seat backrest is provided as the component of the vehicle seat.

3. The safety device as claimed in claim 1, wherein the active headrest is provided as the component of the vehicle seat.

4. The safety device as claimed in claim 2, wherein the active headrest and the seat backrest are positioned in a manner correlated over time.

5. The safety device as claimed in claim 1, wherein a seat cushion, which can be moved in terms of its longitudinal position and/or its inclination, is provided as the component of the vehicle seat.

6. The safety device as claimed in claim 1, wherein a belt system of the vehicle seat is activated before the expected accident event occurs.

7. The safety device as claimed in claim 1, wherein the vehicle seat is a backseat of the motor vehicle.

8. The safety device as claimed in claim 1, wherein the data which is relevant in terms of driving safety includes driving state variables, data about the surroundings and/or evaluated driver activities.

9. The safety device as claimed in claim 1, wherein the active headrest is stopped from moving forward in the normal operating state by spring pre-stress.

10. The safety device as claimed in claim 1, wherein the crash sensor is provided in order to detect a rear-end impact.

11. A method for a safety device for a motor vehicle, comprising an active headrest which is provided on a backrest of a vehicle seat and a control unit, the method comprising the acts of:
actuating, by the control unit, a headrest-deployment device as a function of the evaluation of the signals from a crash sensor when an accident event occurs in such a way that the active headrest is deployed into a headrest position which is optimum in terms of occupant safety; and
actuating, by the control unit, at least one component of the vehicle seat as a function of an evaluation of data which is relevant in terms of driving safety before the expected accident event occurs in such a way that the vehicle seat is moved to an optimum starting position for deploying the active headrest when the accident event occurs.

12. The method of claim 11, wherein a seat backrest is provided as the component of the vehicle seat, and the active headrest and the seat backrest are positioned in a manner correlated over time.

13. The method as claimed in claim 11, wherein a seat cushion, which can be moved in terms of its longitudinal position and/or its inclination, is provided as the component of the vehicle seat.

14. The method as claimed in claim 11, further comprising the act of:
activating a belt system of the vehicle seat before the expected accident event occurs.

15. The method as claimed in claim 11, wherein the data which is relevant in terms of driving safety includes driving state variables, data about the surroundings and/or evaluated driver activities.
